(19) United States
(12) Patent Application Publication
(10) Pub. No.: US 2013/0050443 A1
(43) Pub. Date: Feb. 28, 2013

(54) VIDEO PROCESSING APPARATUS AND VIDEO PROCESSING METHOD

(71) Applicants: Yasuhiro Takahashi, Tokyo (JP); Toshihiro Morohoshi, Kawasaki-Shi (JP); Shinzo Matsubara, Tokyo (JP); Yutaka Irie, Yokohama-Shi (JP)

(72) Inventors: Yasuhiro Takahashi, Tokyo (JP); Toshihiro Morohoshi, Kawasaki-Shi (JP); Shinzo Matsubara, Tokyo (JP); Yutaka Irie, Yokohama-Shi (JP)

(73) Assignee: Kabushiki Kaisha Toshiba, Tokyo (JP)

(21) Appl. No.: 13/403,771

(22) Filed: Feb. 23, 2012

(30) Foreign Application Priority Data
Aug. 31, 2011 (JP) 2011-189622

(51) Int. Cl. H04N 13/04

(52) U.S. Cl. 348/51; 348/E13.075

(57) ABSTRACT

According to one embodiment, a video processing apparatus includes a viewer detector that acquires position information of a viewer from video photographed by a camera, a viewer selector that selects, when a plurality of the viewers are present, a viewer considered to have the highest viewing desire out of the plural viewers taking into account the current time of day and/or information concerning a program being viewed, a viewing area information calculator that calculates, using position information of the selected viewer, a control parameter for setting a viewing area in which the selected viewer is set, a viewing area controller that controls the viewing area according to the control parameter, a display that displays plural parallax images that the viewer present in the viewing area can observe as a stereoscopic video, and an apertural area controller that outputs the plural parallax images displayed on the display in a predetermined direction.

### CROSS-REFERENCE TO RELATED APPLICATIONS

This application is based upon and claims the benefit of priority from the prior Japanese Patent Application No. 2011-189622, filed on Aug. 31, 2011; the entire contents of which are incorporated herein by reference.

### FIELD

Embodiments described herein relate generally to a video processing apparatus and a video processing method.

### BACKGROUND

In recent years, a stereoscopic video display apparatus (a so-called autostereoscopic 3D television) that enables a viewer to see a stereoscopic video with naked eyes without using special glasses is becoming widely used. The stereoscopic video display apparatus displays plural images from different viewpoints. Rays of the images are guided to both eyes of the viewer with an output direction thereof controlled by, for example, a parallax barrier or a lenticular lens. If the position of the viewer is appropriate, since the viewer sees different parallax images with his left eye and his right eye, the viewer can stereoscopically recognize a video. An area where the viewer can see a stereoscopic video is referred to as a viewing area.

The viewing area is a limited area. When the viewer is outside the viewing area, the viewer cannot see the stereoscopic video. Therefore, the stereoscopic video display apparatus has a function of detecting the position of the viewer and controlling the viewing area to include the viewer in the viewing area (a face tracking function).

However, when plural viewers are present, all the viewers are not always set in the viewing area.

### BRIEF DESCRIPTION OF THE DRAWINGS

FIG. 1 is an external view of a video processing apparatus 100 according to an embodiment;

FIG. 2 is a block diagram showing a schematic configuration of the video processing apparatus 100 according to the embodiment;

FIG. 3 is a diagram of a part of a liquid crystal panel 1 and a lenticular lens 2 viewed from above;

FIG. 4 is a top view showing an example of plural viewing areas 21 in a view area P of the video processing apparatus;

FIG. 5 is a block diagram showing a schematic configuration of a video processing apparatus 100′ according to a modification;

FIG. 6(a) is a diagram showing an example of user registration information and FIG. 6(b) is a diagram showing an example of a database for viewer selection;

FIG. 7 is a diagram showing an example of a viewing history information;

FIG. 8 is a flowchart for explaining a video processing method according to one embodiment; and

FIG. 9 is a top view showing a viewing area set by the video processing method according to one embodiment.

### DETAILED DESCRIPTION

According to one embodiment, a video processing apparatus includes a viewer detector that acquires position information of a viewer from a video photographed by a camera, a viewer selector that selects, when a plurality of the viewers are present, a viewer considered to have the highest viewing desire out of the plural viewers taking into account the current time of day and/or information concerning a program being viewed, a viewing area information calculator that calculates, using position information of the selected viewer, a control parameter for setting a viewing area in which the selected viewer is set, a viewing area controller that controls the viewing area according to the control parameter, a display that displays plural parallax images that the viewer present in the viewing area can observe as a stereoscopic video, and an apertural area controller that outputs the plural parallax images displayed on the display in a predetermined direction.

Embodiments will now be explained with reference to the accompanying drawings.

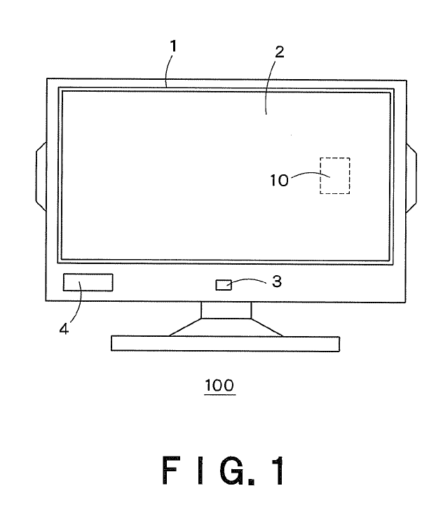

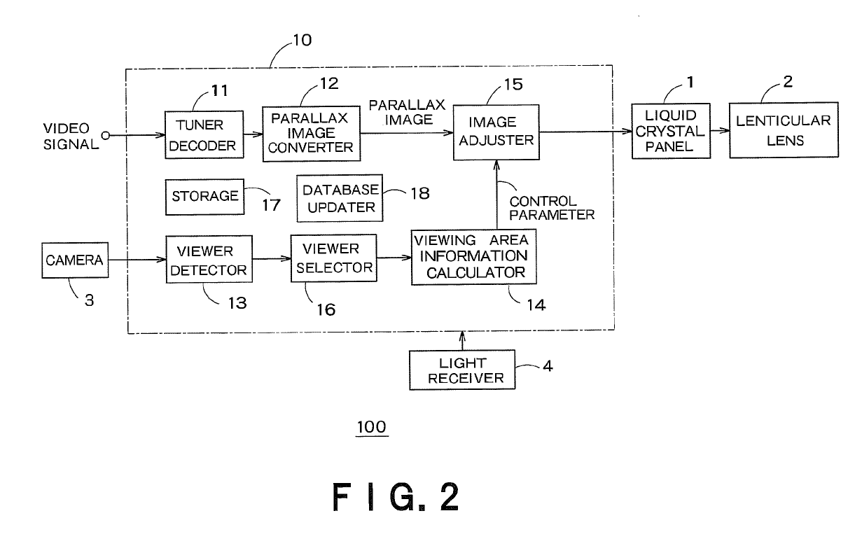

FIG. 1 is an external view of a video display apparatus 100 according to an embodiment. FIG. 2 is a block diagram showing a schematic configuration of the video display apparatus 100. The video display apparatus 100 includes a liquid crystal panel 1, a lenticular lens 2, a camera 3, a light receiver 4, and a controller 10.

The liquid crystal panel (a display) 1 displays plural parallax images that a viewer present in a viewing area can observe as a stereoscopic video. The liquid crystal panel 1 is, for example a 55-inch size panel. 11520 (=1280*9) pixels are arranged in the horizontal direction and 720 pixels are arranged in the vertical direction. In each of the pixels, three sub-pixels, i.e., an R sub-pixel, a G sub-pixel, and a B sub-pixel are formed in the vertical direction. Light is irradiated on the liquid crystal panel 1 from a backlight device (not shown) provided in the back. The pixels transmit light having luminance corresponding to a parallax image signal (explained later) supplied from the controller 10.

The lenticular lens (an apertural area controller) 2 outputs the plural parallax images displayed on the liquid crystal panel 1 (the display) in a predetermined direction. The lenticular lens 2 includes plural convex portions arranged along the horizontal direction of the liquid crystal panel 1. The number of the convex portions is 1/9 of the number of pixels in the horizontal direction of the liquid crystal panel 1. The lenticular lens 2 is stuck to the surface of the liquid crystal panel 1 such that one convex portion corresponds to nine pixels arranged in the horizontal direction. The light transmitted through the pixels is output, with directivity, in a specific direction from near the vertex of the convex portion.

The liquid crystal panel 1 according to this embodiment can display a stereoscopic video in an integral imaging manner of three or more parallaxes or a stereo imaging manner. Besides, the liquid crystal panel 1 can also display a normal two-dimensional video.

In the following explanation, an example in which nine pixels are provided to correspond to the convex portions of the liquid crystal panel 1 and an integral imaging manner of nine parallaxes can be adopted is explained. In the integral imaging manner, first to ninth parallax images are respectively displayed on the nine pixels corresponding to the convex portions. The first to ninth parallax images are images of a subject seen respectively from nine viewpoints arranged along the horizontal direction of the liquid crystal panel 1. The viewer can stereoscopically view a video by seeing one parallax image among the first to ninth parallax images with his left eye and seeing another one parallax image with his right eye. According to the integral imaging manner, a viewing area can be expanded as the number of parallaxes is increased. The viewing area means an area where a video can be stereoscopically viewed when the liquid crystal panel 1 is seen from the front of the liquid crystal panel 1.

On the other hand, in the stereo imaging manner, parallax images for the right eye are displayed on four pixels among the nine pixels corresponding to the convex portions and parallax images for the left eye are displayed on the other five pixels. The parallax images for the left eye and the right eye are images of the subject viewed respectively from a viewpoint on the left side and a viewpoint on the right side of two viewpoints arranged in the horizontal direction. The viewer can stereoscopically view a video by seeing the parallax images for the left eye with his left eye and seeing the parallax images for the right eye with his right eye through the lenticular lens 2. According to the stereo imaging manner, feeling of three-dimensionality of a displayed video is more easily obtained than the integral imaging manner. However, a viewing area is narrower than that in the integral imaging manner.

The liquid crystal panel 1 can also display the same image on the nine pixels corresponding to the convex portions and display a two-dimensional image.

In this embodiment, the viewing area can be variably controlled according to a relative positional relation between the convex portions of the lenticular lens 2 and displayed parallax images, i.e., what kind of parallax images are displayed on the nine pixels corresponding to the convex portions. The control of the viewing area is explained below taking the integral imaging manner as an example.

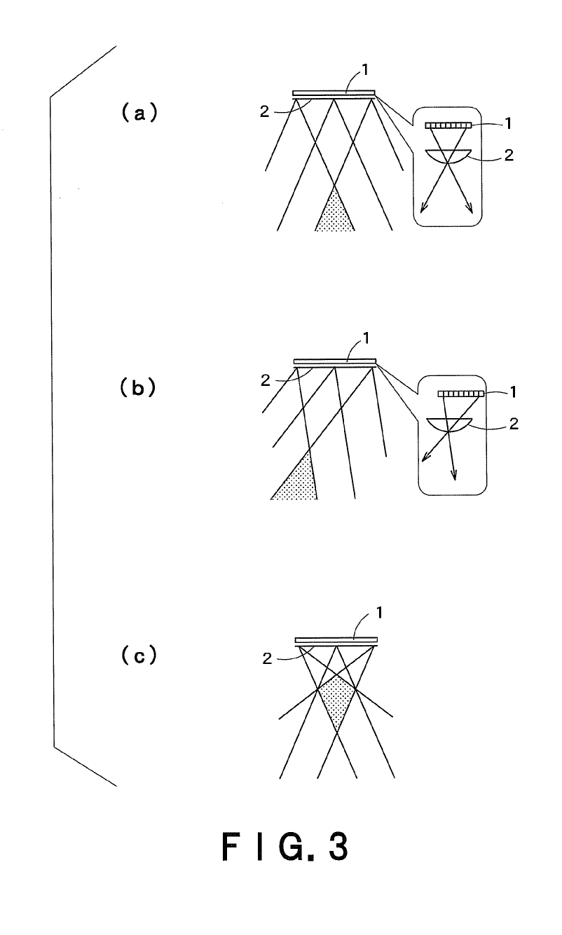

FIG. 3 is a diagram of a part of the liquid crystal panel 1 and the lenticular lens 2 viewed from above. A hatched area in the figure indicates the viewing area. The viewer can stereoscopically view a video when the viewer sees the liquid crystal panel 1 from the viewing area. Other areas are areas where a pseudoscopic image and crosstalk occur and areas where it is difficult to stereoscopically view a video.

FIG. 3 shows a relative positional relation between the liquid crystal panel 1 and the lenticular lens 2, more specifically, a state in which the viewing area changes according to a distance between the liquid crystal panel 1 and the lenticular lens 2 or a deviation amount in the horizontal direction between the liquid crystal panel 1 and the lenticular lens 2.

Actually, the lenticular lens 2 is stuck to the liquid crystal panel 1 while being highly accurately aligned with the liquid crystal panel 1. Therefore, it is difficult to physically change relative positions of the liquid crystal panel 1 and the lenticular lens 2.

Therefore, in this embodiment, display positions of the first to ninth parallax images displayed on the pixels of the liquid crystal panel 1 are shifted to apparently change a relative positional relation between the liquid crystal panel 1 and the lenticular lens 2 to thereby perform adjustment of the viewing area.

For example, compared with a case in which the first to ninth parallax images are respectively displayed on the nine pixels corresponding to the convex portions (FIG. 3(a)), when the parallax images are shifted to the right side as a whole and displayed (FIG. 3(b)), the viewing area moves to the left side. Conversely, when the parallax images are shifted to the left side as a whole and displayed, the viewing area moves to the right side.

When the parallax images are not shifted near the center in the horizontal direction and the parallax images are more largely shifted to the outer side and displayed further on the outer side of the liquid crystal panel 1 (FIG. 3(c)), the viewing area moves in a direction in which the viewing area approaches the liquid crystal panel 1. Further a pixel between a parallax image to be shifted and a parallax image not to be shifted and a pixel between parallax images having different shift amounts only have to be appropriately interpolated according to pixels around the pixels. Conversely to FIG. 3(c), when the parallax images are not shifted near the center in the horizontal direction and the parallax images are more largely shifted to the center side and displayed further on the outer side of the liquid crystal panel 1, the viewing area moves in a direction in which the viewing area is away from the liquid crystal panel 1.

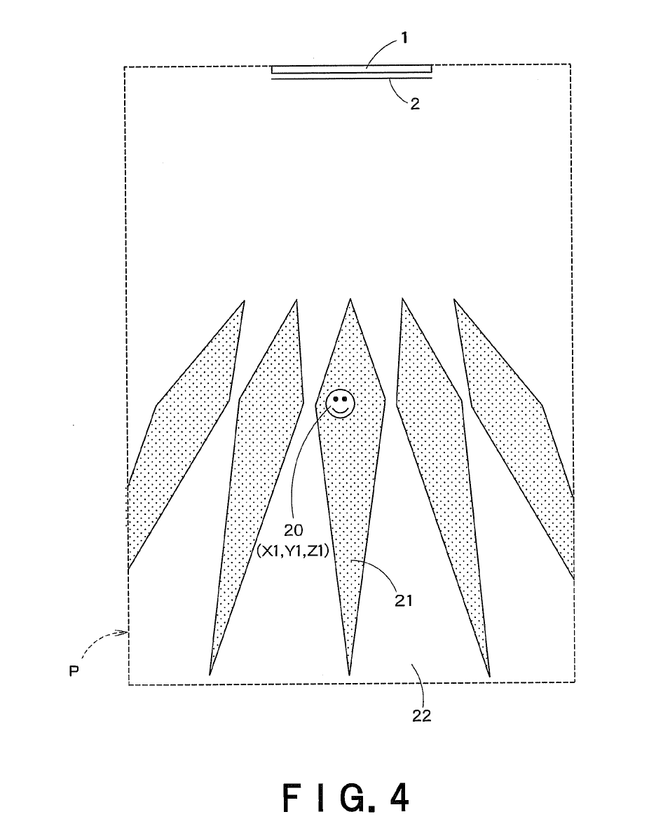

By shifting and displaying all or a part of the parallax images in this way, it is possible to move the viewing area in the left right direction or the front back direction with respect to the liquid crystal panel 1. In FIG. 3, only one viewing area is shown to simplify the explanation. However, actually, as shown in FIG. 4, plural viewing areas 21 are present in the view area P and move in association with one another. The viewing area is controlled by the controller 10 shown in FIG. 2 explained later. Further a view area other than the viewing areas 21 is a pseudoscopic image area 22 where it is difficult to see a satisfactory stereoscopic video because of occurrence of a pseudoscopic image, crosstalk, or the like.

Referring back to FIG. 1, the components of the video processing apparatus 100 are explained.

The camera 3 is attached near the center in a lower part of the liquid crystal panel 1 at a predetermined angle of elevation and photographs a predetermined range in the front of the liquid crystal panel 1. A photographed video is supplied to the controller 10 and used to detect information concerning the viewer such as the position, the face, and the like of the viewer. The camera 3 may photograph either a moving image or a still image.

The light receiver 4 is provided, for example, on the left side in a lower part of the liquid crystal panel 1. The light receiver 4 receives an infrared ray signal transmitted from a remote controller used by the viewer. The infrared ray signal includes a signal indicating, for example, whether a stereoscopic video is displayed or a two-dimensional video is displayed, which of the integral imaging manner and the stereo imaging manner is adopted when the stereoscopic video is displayed, and whether control of the viewing area is performed.

Next, details of the components of the controller 10 are explained. As shown in FIG. 2, the controller 10 includes a tuner decoder 11, a parallax image converter 12, a viewer detector 13, a viewing area information calculator 14, an image adjuster 15, a viewer selector 16, a storage 17, and a database updater 18. The controller 10 is implemented as, for example, one IC (Integrated Circuit) and arranged on the rear side of the liquid crystal panel 1. It goes without saying that a part of the controller 10 is implemented as software.

The tuner decoder (a receiver) 11 receives and tunes an input broadcast wave and decodes an encoded video signal. When a signal of a data broadcast such as an electronic program guide (EPG) is superimposed on the broadcast wave, the tuner decoder 11 extracts the signal. Alternatively, the tuner decoder 11 receives, rather than the broadcast wave, an encoded video signal from a video output apparatus such as an optical disk player or a personal computer and decodes the video signal. The decoded signal is also referred to as baseband video signal and is supplied to the parallax image converter 12. Note that when the video display apparatus 100 does not receive a broadcast wave and solely displays a video signal received from the video output apparatus, a decoder simply having a decoding function may be provided as a receiver instead of the tuner decoder 11.

A video signal received by the tuner decoder 11 may be a two-dimensional video signal or may be a three-dimensional video signal including images for the left eye and the right eye in a frame packing (FP), side-by-side (SBS), or top-and-bottom (TAB) manner and the like. The video signal may be a three-dimensional video signal including images having three or more parallaxes.

In order to stereoscopically display a video, the parallax image converter 12 converts a baseband video signal into plural parallax image signals and supplies the parallax image signals to the image adjuster 15. Processing content of the parallax image converter 12 is different according to which of the integral imaging matter and the stereo imaging manner is adopted. The processing content of the parallax image converter 12 is different according to whether the baseband video signal is a two-dimensional video signal or a three-dimensional video signal.

When the stereo imaging manner is adopted, the parallax image converter 12 generates parallax image signals for the left eye and the right eye respectively corresponding to the parallax images for the left eye and the right eye. More specifically, the parallax image converter 12 generates the parallax image signals as explained below.

When the stereo imaging manner is adopted and a three-dimensional video signal including images for the left eye and the right eye is input, the parallax image converter 12 generates parallax image signals for the left eye and the right eye that can be displayed on the liquid crystal panel 1. When a three-dimensional video signal including three or more images is input, the parallax image converter 12 generates parallax image signals for the left eye and the right eye using, for example, arbitrary two of the three images.

In contrast, when the stereo imaging manner is adopted and a two-dimensional video signal not including parallax information is input, the parallax image converter 12 generates parallax image signals for the left eye and the right eye on the basis of depth values of pixels in the video signal. The depth value is a value indicating to which degree the pixels are displayed to be seen in the front or the depth with respect to the liquid crystal panel 1. The depth value may be added to the video signal in advance or may be generated by performing motion detection, composition identification, human face detection, and the like on the basis of characteristics of the video signal. In the parallax image for the left eye, a pixel seen in the front needs to be displayed to be shifted further to the right side than a pixel seen in the depth. Therefore, the parallax image converter 12 performs processing for shifting the pixel seen in the front in the video signal to the right side and generates a parallax image signal for the left eye. A shift amount is set larger as the depth value is larger.

On the other hand, when the integral imaging manner is adopted, the parallax image converter 12 generates first to ninth parallax image signals respectively corresponding to the first to ninth parallax images. More specifically, the parallax image converter 12 generates the first to ninth parallax image signals as explained below.

When the integral imaging manner is adopted and a two-dimensional video signal or a three-dimensional video signal including images having eight or less parallaxes is input, the parallax image converter 12 generates the first to ninth parallax image signals on the basis of depth information same as that for generating the parallax image signals for the left eye and the right eye from the two-dimensional video signal.

When the integral imaging manner is adopted and a three-dimensional video signal including images having nine parallaxes is input, the parallax image converter 12 generates the first to ninth parallax image signals using the video signal.

The viewer detector 13 performs face recognition using a video photographed by the camera 3 and acquires information concerning the viewer (e.g., face information and position information of the viewer) and supplies the information to a viewer selector 16 explained later. The viewer detector 13 can also track the viewer even if the viewer moves. Therefore, it is also possible to grasp a viewing time for each viewer.

The position information of the viewer is represented as, for example, a position on an X axis (in the horizontal direction), a Y axis (in the vertical direction), and a Z axis (a direction orthogonal to the liquid crystal panel 1) with the origin set in the center of the liquid crystal panel 1. The position of a viewer 20 shown in FIG. 4 is represented by a coordinate (X1, Y1, Z1). More specifically, first, the viewer detector 13 detects a face from a video photographed by the camera 3 to thereby recognize the viewer. Subsequently, the viewer detector 13 calculates a position (X1, Y1) on the X axis and the Y axis from the position of the viewer in the video and calculates a position (Z1) on the Z axis from the size of the face. When there are plural viewers, the viewer detector 13 may detect a predetermined number of viewers, for example, ten viewers. In this case, when the number of detected faces is larger than ten, for example, the viewer detector 13 detects positions of the ten viewers in order from a position closest to the liquid crystal panel 1, i.e., a smallest position on the Z axis.

The viewing area information calculator 14 calculates, using the position information of the viewer selected by the viewer selector 16 explained later, a control parameter for setting a viewing area in which the selected viewer is set. The control parameter is, for example, an amount for shifting the parallax images explained with reference to FIG. 3 and is one parameter or a combination of plural parameters. The viewing area information calculator 14 supplies the calculated control parameter to the image adjuster 15.

More specifically, in order to set a desired viewing area, the viewing area information calculator 14 uses a viewing area database that associates the control parameter and a viewing area set by the control parameter. The viewing area database is stored in the storage 17 in advance. The viewing area information calculator 14 finds, by searching through the viewing area database, a viewing area in which the selected viewer can be included.

In order to control the viewing area, after performing adjustment for shifting and interpolating a parallax image signal according to the calculated control parameter, the image adjuster (a viewing area controller) 15 supplies the parallax image signal to the liquid crystal panel 1. The liquid crystal panel 1 displays an image corresponding to the adjusted parallax image signal.

When plural viewers are present, the viewer selector 16 selects a viewer considered to have the highest viewing desire out of the plural viewers taking into account the current time of day and/or information concerning a program being viewed. The viewer selector 16 supplies position information of the selected viewer to the viewing area information calculator 14.

The storage 17 is a nonvolatile memory such as a flash memory. The storage 17 stores, besides a viewing area database, user registration information and a database for viewer selection (both explained later) and the like. The storage 17 may be provided on the outside of the controller 10.

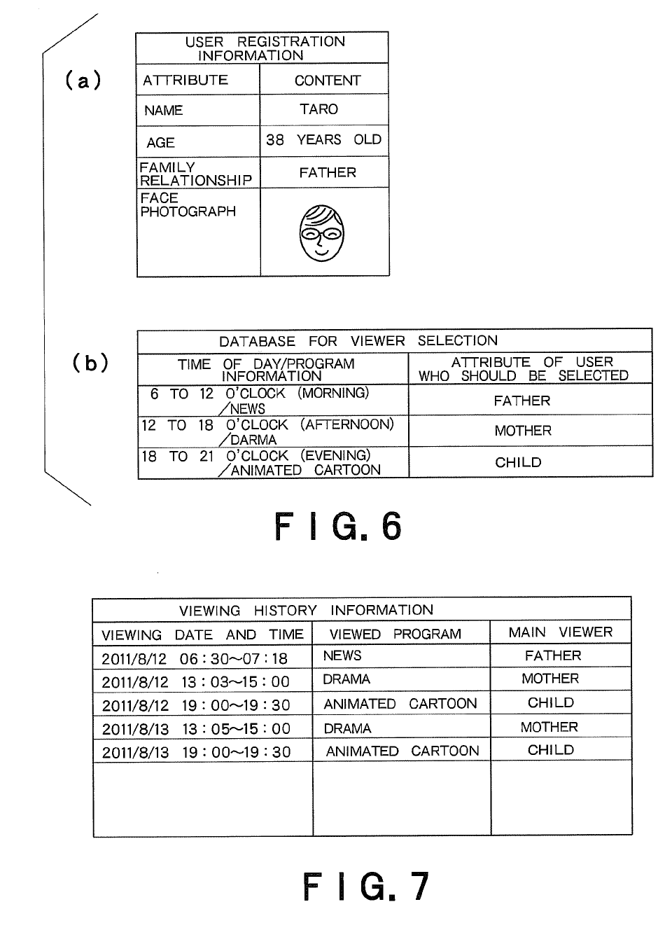

The user registration information, which is information concerning a user of the video processing apparatus 100, is explained. The user registration information includes information concerning attributes such as a name, an age, family relationship (father, mother, child, etc.), and a face photograph. The user registration information is set for each user and stored in the storage 17. The attributes are characteristics that characterize the user. FIG. 6(a) shows an example of the user registration information. In this example, the attributes of the user are a name, an age, family relationship, and a face photograph. Content of the attribute “family relationship” is “father”.

The database for viewer selection is a database that associates a time of day and/or program information and an attribute of a user who should be selected with each other. FIG. 6(b) shows an example of the database for viewer selection. In this example, the time of day and the program information and an attribute (family relationship) of a user who should be selected are associated with each other. The database for viewer selection may associate the time of day and the attribute of the user who should be selected with each other or may associate the program information and the attribute of the user who should be selected with each other.

The database for viewer selection may be set by a user or may be automatically updated according to a viewing history by a database updater 18 explained later. In the database for viewer selection, a time frame (e.g., 6 to 12 o'clock as a time frame in the morning) may be used instead of the time of day. The program information of the database for viewer selection may be a specific program name besides a genre of a program as shown in FIG. 6(b).

The database updater 18 creates viewing history information in which date and time of viewing and/or a viewed program and a main viewer are associated with each other. The database updater 18 updates, on the basis of the viewing history information, the attribute of the user who should be selected in the database for viewer selection. When one viewer is present, the main viewer is the viewer. When plural viewers are present, the main viewer is a viewer considered to have high viewing desire (e.g., a viewer who operates a remote controller or the like and adjusts a viewing area to set the viewer in the viewing area). FIG. 7 shows an example of the viewing history information created by the database updater 18. In this example, viewing date and time and a viewed program and the main viewer are associated with each other. In the viewing history information, the viewing date and time and the main viewer may be associated with each other or viewed program information and the main viewer may be associated with each other.

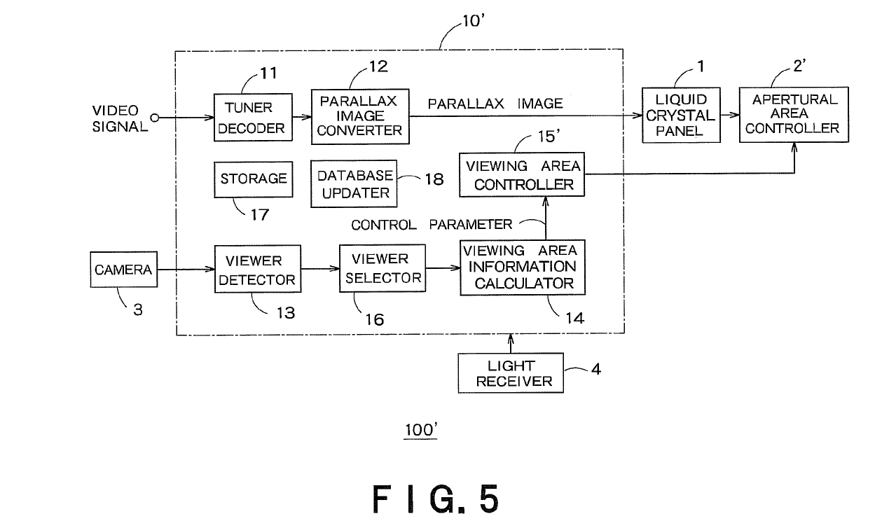

The configuration of the video processing apparatus 100 is explained above. In this embodiment, the example in which the lenticular lens 2 is used and the viewing area is controlled by shifting the parallax image is explained. However, the viewing area may be controlled by other methods. For example, a parallax barrier may be provided as an apertural area controller 2′ instead of the lenticular lens 2. FIG. 5 is a block diagram showing a schematic configuration of a video processing apparatus 100′ according to a modification of this embodiment shown in FIG. 2. As shown in the figure, a controller 10′ of the video processing apparatus 100′ includes a viewing area controller 15′ instead of the image adjuster 15. The viewing area controller 15′ controls an apertural area controller 2′ according to a control parameter calculated by the viewing area information calculator 14. In the case of this modification, the control parameter is a distance between the liquid crystal panel 1 and the apertural area controller 2′, a deviation amount in the horizontal direction between the liquid crystal panel 1 and the apertural area controller 2′, and the like.

In this modification, an output direction of a parallax image displayed on the liquid crystal panel 1 is controlled by the apertural area controller 2′, whereby the viewing area is controlled. In this way, the apertural area controller 2′ may be controlled by the viewing area controller 15′ without performing processing for shifting the parallax image.

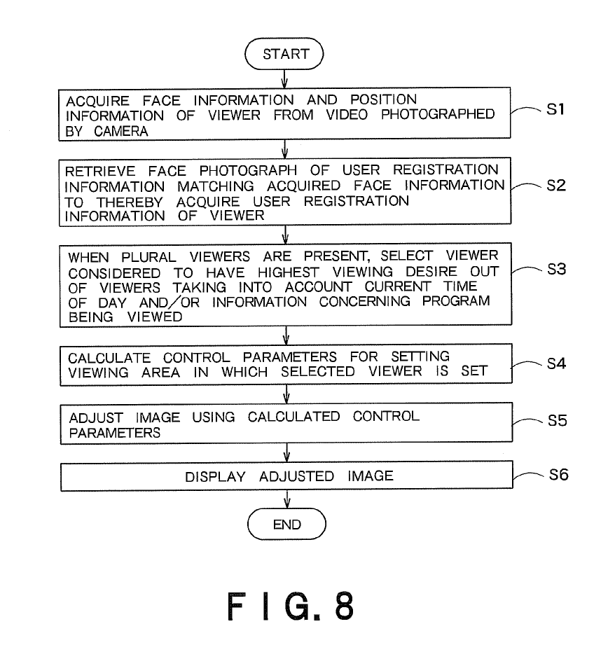

Next, a video processing method by the video processing apparatus 100 (100′) configured as explained above is explained with reference to the flowchart of FIG. 8.

(1) The viewer detector 13 acquires position information and face information of a viewer from a video photographed by the camera 3 (step S1).

(2) The viewer detector 13 retrieves user a face photograph of the user registration matching the acquired face information to thereby acquire user registration information of the viewer (step S2). Thereafter, the viewer detector 13 supplies the position information and the user registration information of the viewer to the viewer selector 16.

(3) When plural viewers are present, the viewer selector 16 selects a viewer considered to have the highest viewing desire out of the viewers taking into account the current time of day and/or information concerning a program being viewed (step S3). After selecting the viewer, the viewer selector 16 supplies position information of the selected viewer to the viewing area information calculator 14.

(4) The viewing area information calculator 14 calculates control parameters for setting a viewing area in which the selected viewer (one) is set (step S4).

Further, the viewing area information calculator 14 may calculate control parameters for setting a viewing area in which the selected viewer is set in a position where a highest-quality stereoscopic video can be seen (e.g., the center of the viewing area).

(5) The image adjuster 15 adjusts an image (a parallax image signal) using the control parameters calculated in step S4 and supplies the image to the liquid crystal panel 1 (step S5).

Further, in the case of the video processing apparatus 100′ according to the modification, the viewing area controller 15′ controls the apertural area controller 2′ using the control parameters calculated in step S4.

(6) The liquid crystal panel 1 displays the image adjusted by the image adjuster 15 in step S5 (step S6).

Further, in the case of the video processing apparatus 100′ according to the modification, the liquid crystal panel 1 displays an image supplied from the parallax image converter 12.

Next, details of step S3 are explained. In this embodiment, the viewer selector 16 searches for, among user registration information of viewers supplied from the viewer detector 13, user registration information in which content of an attribute coincides with content of the attribute of the user who should be selected associated with the current time of day and/or the information concerning the program being viewed. Further, the information concerning the program being viewed can be obtained from an electronic program guide (EPG) superimposed on a broadcast wave.

For example, when the current time of day is 9 o'clock (in the morning) and the program being viewed is news, according to the database for viewer selection in FIG. 6(b), the attribute of the user who should be selected is father. Therefore, in this case, the user registration information shown in FIG. 6(a) is user registration information set as a target of the search. If user registration information in which the family relationship is father is present among the user registration information of the viewers supplied from the viewer detector 13, the viewer selector 16 selects a viewer of the user registration information (i.e., Taro).

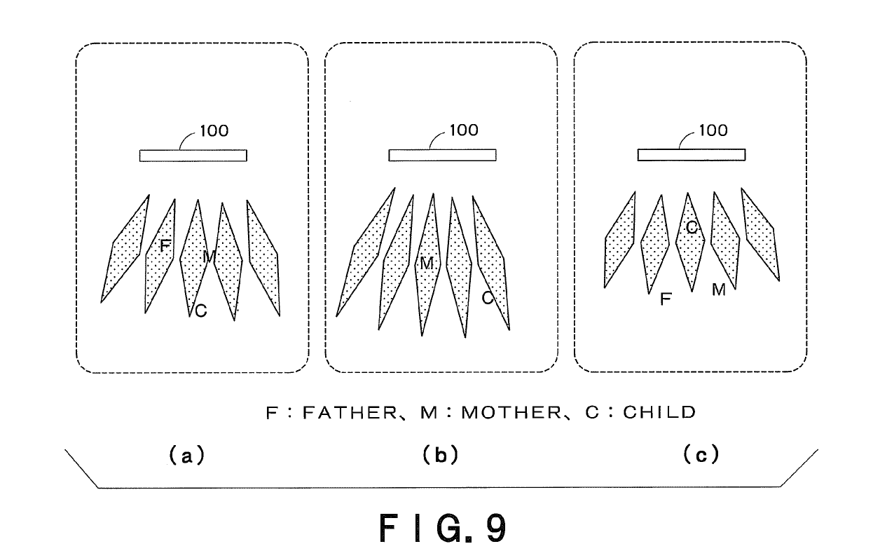

FIG. 9(a) shows a case in which a viewing area is controlled to set a father (F) in the viewing area. Similarly, FIG. 9(b) shows a case in which the current time of day is 15 o'clock (in the afternoon) and the program being viewed is a drama. The viewing area is controlled to set a mother (M) in the viewing area. Similarly, FIG. 9(c) shows a case in which the current time of day is 19 o'clock (in the evening) and the program being viewed is an animated cartoon. The viewing area is controlled to set a child (C) in the viewing area.

As explained above, in this embodiment, the viewer selector 16 searches for, among the user registration information of the viewers, user registration information in which content of an attribute coincides with content of the attribute of the user who should be selected associated with the current time of day and/or the information concerning the program being viewed and selects a viewer of the coinciding user registration information. In other words, the viewer selector 16 grasps the current time of day and/or the information concerning the program being viewed and selects a viewer of user registration information having an attribute coinciding with content of the attribute of the database for viewer selection.

As explained above, a specific viewer considered to have high viewing desire is selected out of the plural viewers according to the current time of day and/or the program being viewed and a viewing area is set in which the viewer is set. Consequently, according to this embodiment, the viewer considered to have high viewing desire can view a high-quality stereoscopic video.

Further, in this embodiment, the controller 10 includes the database updater 18 that updates the database for viewer selection on the basis of viewing history information. Consequently, since it is possible to select a viewer reflecting a viewing history, it is possible to improve accuracy of viewer selection. In addition, since update work for the database for viewer selection by the user is unnecessary, it is possible to provide a more convenient video processing apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video processing apparatus comprising:
a viewer detector configured to acquire position information for each of a plurality of viewers from an image captured by a camera;
a viewer selector configured to select, when the plurality of viewers are present, a first viewer based on priority information comprising a current time and/or information concerning a program being viewed;
a calculator configured to calculate, using the position information of the first viewer, a control parameter for setting a viewing area corresponding to where the first viewer is;
a viewing area controller configured to control the viewing area according to the control parameter;
a display configured to display plural parallax images that the first viewer present in the viewing area can observe as a stereoscopic video; and
an apertural area controller configured to output the plural parallax images displayed on the display in a first direction.

2. The video processing apparatus of claim 1, further comprising a storage configured to store a database for viewer selection that associates a time of day and/or program information and an attribute of a user who should be selected with each other and user registration information comprising a face photograph as one of attributes, wherein
the viewer detector configured to acquire face information of the plurality of viewers from the image captured by the camera and retrieves the face photograph matching the face information to thereby acquire the user registration information of the plurality of viewers, and
the viewer selector is configured to search for, among the user registration information of the plurality of viewers, the user registration information where content of the attribute coincides with content of the attribute of the user who should be selected associated with the current time and/or the information concerning the program being viewed and to select a viewer of the matching user registration information.

3. The video processing apparatus of claim 2, further comprising a database updater configured to create viewing history information where date and time of viewing and/or a viewed program and a main viewer are associated with each other and to update the attribute of the user who should be selected in the database for viewer selection based on the viewing history information.

4. The video processing apparatus of claim 3, wherein the main viewer is a viewer who adjusts the viewing area to set the viewer in the viewing area.

5. The video processing apparatus of claim 2, wherein the calculator is configured to calculate a control parameter for setting a viewing area corresponding to where the first viewer is set in a position where a highest-quality stereoscopic video can be seen.

6. A video processing method comprising:
acquiring position information for each of a plurality of viewers from an image captured by a camera;
selecting, when the plurality of viewers are present, a first viewer based upon priority information comprising a current time and/or information concerning a program being viewed;
calculating, using position information of the first viewer, a control parameter for setting a viewing area corresponding to where the first viewer is; and
controlling the viewing area according to the control parameter.

7. The video processing method of claim 6, further comprising:
storing in advance, in a storage, a database for viewer selection that associates a time of day and/or program information and one or more attributes of a user who should be selected with each other and user registration information comprising a face photograph as one of the attributes;
acquiring face information of the viewer when acquiring the position information; and
retrieving, before selecting the viewer considered to have the highest priority, the face photograph matching the face information to thereby acquire the user registration information of the plurality of viewers, wherein
the selection of the viewer considered to have the highest priority is performed by searching for, among the user registration information of the viewers, the user registration information where content of the attribute matches the content of the attribute of the user who should be selected associated with the current time and/or the information concerning the program being viewed and selecting a viewer of the matching user registration information.

8. The video processing method of claim 7, further comprising creating viewing history information in which date and time of viewing and/or a viewed program and a main viewer are associated with each other and updating the attribute of the user who should be selected in the database for viewer selection, based on the viewing history information.

9. The video processing method of claim 8, wherein the main viewer is a viewer who adjusts the viewing area to set the viewer in the viewing area.

10. The video processing method of claim 7, wherein the calculation of the control parameter is performed to set a viewing area corresponding to where the first viewer is set in a position where a highest-quality stereoscopic video can be seen.
